(19) United States
(12) Patent Application Publication
(10) Pub. No.: US 2019/0262894 A1
(43) Pub. Date: Aug. 29, 2019

(54) USE OF A CEMENTITIOUS COMPOSITION AS A COATING FOR DISPOSABLE FOUNDRY CORES AND RELATIVE COATED CORE

(71) Applicant: ITALCEMENTI S.p.A., Bergamo (IT)

(72) Inventors: Roberto CUCITORE, Bergamo (IT); Maurizio Iler MARCHI, Melzo (IT); Gianluca LEZZI, Bergamo (IT); Marco ORLANDO, Dalmine (IT)

(73) Assignee: ITALCEMENTI S.p.A., Bergamo (IT)

(21) Appl. No.: 16/308,266

(22) PCT Filed: Jun. 8, 2017
(86) PCT No.: PCT/IB2017/053395

§ 371 Date: Dec. 7, 2018

(30) Foreign Application Priority Data
Jun. 9, 2016 (IT) UA2016A004227

(51) Int. Cl. B22C 3/00; C04B 7/02; C04B 7/32; C04B 41/48; B22C 9/18

(52) U.S. Cl. CPC B22C 3/00; C04B 7/02; C04B 7/323; C04B 2111/0037; C04B 41/483; B22C 9/18; C04B 41/4803

(57) ABSTRACT

The use of a cementitious composition is described, as a coating for disposable foundry cores, said cementitious composition comprising at least one binder or hydraulic cement in a quantity ranging from 40% to 99.9% by weight with respect to the total weight of the cementitious composition; possibly one or more fillers in a quantity ranging from 0.1% to 60% by weight, with respect to the total weight of the cementitious composition, said filler preferably having a D99<100 μm; at least one rheology modifying agent selected from cellulose, derivatives of cellulose such as methylhydroxyethylcellulose, vinyl acetate/versatate copolymers, polycarboxylate ether polymer, or a mixture thereof, in a quantity ranging from 0.1% to 5% by weight with respect to the total weight of the cementitious composition. A disposable foundry core is also described, having at least one coating layer based on said cementitious composition.

The present invention relates to a cementitious composition as a coating for disposable foundry cores and the relative coated core.

In recent years, the foundry industry has had a growing demand for high-value pieces, frequently characterized by complicated forms or thin walls, and which, at the same time, must meet increasing requirements in terms of mechanical strength and surface qualities.

Modern casting processes therefore require improved performances also for foundry cores, in particular disposable foundry cores. The production and use of the same must also comply with increasingly stringent requirements with respect to environmental impact (Legislative Decree No. 152/06 Part V).

As most foundry processes adopt disposable cores, the need is particularly felt for having disposable foundry cores that have high mechanical characteristics, which allow manufactured products characterized by an optimum surface finish to be obtained, that have a reduced environmental impact, that can be stored under standard warehouse conditions without losing their mechanical properties and which, at the same time, can be easily removed at the end of the cooling of the metal or alloy.

Foundry production processes are processes through which end-products can be obtained by casting the metal directly in the liquid state into suitable forms. The most widely-used metals are cast iron, steels and alloys of Al, Mg, Zn, Ti, Cu and Ni.

The advantages of this type of production mainly lie, as already indicated, in the possibility of also obtaining extremely complex pieces and with internal cavities, in the speed of implementation and in the economic convenience, above all when the piece has a complicated form and the material used has a low machinability.

The main steps of a foundry production process are:
melting and treatment of the metal or alloy;
forming of the mould;
forming of the cores;
casting of the metal or alloy into the mould and subsequent cooling until solidification;
shakeout (i.e. extraction of the piece from the mould);
desanding (i.e. emptying the interior of the piece from the sand coming from the cores);
possible finishing of the piece.

The casting can be effected in permanent moulds or in disposable moulds (also called transitional moulds): the former are normally moulds made of alloyed steel or special cast iron and are constructed for being used various times; the latter, on the other hand, are used only once, and are moulds normally made of sandy material bound/held together with organic or inorganic binders, and require a forming process. The forming process is both the preparation process of the mould, i.e. the container into the which the metal or alloy is poured, and also the preparation process of the cores. A core is an object which, when positioned inside a mould, allows the formation of a cavity inside the metallic manufactured product, preventing the molten metal from filling the whole space inside the mould. During the desanding step, the disposable cores are normally destroyed with various kinds of mechanical processes (for example, by applying a vibration, or striking them with a strong jet of water) or with thermal processes (if organic binders are used) to free the piece and obtain the metallic manufactured product with the desired cavities.

Similarly to what happens with the moulds, the forming of disposable foundry cores can be effected through various processes that differ in the type of binder used and activation mode. The choice of the forming process to be adopted depends on numerous parameters such as, for example:

a) pressure resistance: the pressure and its distribution vary in relation to the density of the metal used and temperature, and also in relation to the metallostatic swing; other variables relating to dynamic phenomena must also be considered, which are a result of the type of casting (gravity casting, centrifugal casting, die casting, etc.);

b) desired surface finish level for the metal parts in contact with the cores; c) ease of removal after the solidification of the casting (also known as desanding aptitude), an important requirement above all for cavities having complicated forms, such as, for example, those involving one or more undercut geometries;

d) limited or zero release into the environment of fumes, vapours and undesired substances when the cores come into contact with the molten metal;

e) limited or zero development of fumes and vapours when the cores come into contact with the molten metal in order to avoid harmful effects for the quality of the piece being melted, generating blowing, porosity and/or deformation;

f) disposability at the end of the processing cycle or re-use of part of the core after treatment (which, for example, can comprise regrinding and washing) and re-forming;

g) geometry of the cavity and, in particular, length/diameter ratio: this ratio in fact represents a limit to the use of some technologies.

For the forming of disposable cores, organic or inorganic binders can be used, with hardening effected through cold or hot methods. The term “cold methods” refers to methods which are substantially carried out at room temperature without heating the mould of the core. In hot methods, the mixture of core material, after being modelled, is heated to a temperature generally within the range of 100 to 300° C. to extract the solvent present in the binder or to trigger a chemical hardening reaction, for example by means of crosslinking.

An example of a cold method for the production of cores with organic binders is described in U.S. Pat. No. 3,409,579, in which the binding system comprises two components: a phenolic resin and a polyisocyanate solution. An example of a hot method which comprises the use of phenolic resins hardened by flushing with high-temperature CO₂ is described in WO2003/016400A1.

Methods involving the use of organic binders, however, are generally characterized in that the binders, due to the high temperature of the molten metal, become degraded, releasing harmful substances such as benzene, toluene, xylenes (BTX), phenols, formaldehyde, nitrogen oxides (NOx) and other dangerous contaminants for the air (HAP). Furthermore, the binder that remains is transformed into tar or coal that can re-condense on the sand or on the surface of the metallic end-product.

The use of inorganic binders, which avoids the emission of decomposition products during casting operations, is described, for example, in U.S. Pat. No. 2,895,838, which uses a binder based on silicates and phosphates, hardened by flushing with CO₂ at room temperature, or in EP796681A2 in which the binder based on silicates and phosphates is hardened by thermal treatment at 120° C.

Inorganic binders, however, also have various critical aspects. Some inorganic binders, for example, are not suitable for cast iron foundry processes, which typically take place at temperatures ranging from 1,200° C. to 1,300° C.

A further limit consists in the fact that binders based on sodium silicate, for example, generally have a low mechanical strength and storage problems due to their high sensitivity to humidity. Furthermore, in many cases, the roughness and porosity of the surface of the cores do not allow the desired finishing level to be obtained on the metallic end-product. In the specific case of aluminium foundries, the chemical interaction between the sodium silicate and molten aluminium causes the formation of surface defects, due to chemical reactions and the penetration of molten aluminium into the core.

An alternative solution which improves the finish of manufactured metal products, comprises painting the moulds and cores. The paints currently used for disposable cores are alcohol-based or water-based varnishes/paints. The former, however, have an excessive application complexity and dangerousness, as they must be dried by means of flame treatment (such as for example alcohol paints/graphite), whereas the latter result in a loss of mechanical strength of the core when the core is produced with inorganic binders. In the case of cores produced with the CORDIS method (C. Mingardi, presentation “Processo CORDIS” in the event “Supernova 2015”, Feb. 10, 2015 Brescia (BS), Italy), for example, it is expressly described that, in the presence of environmental humidity, the cores have significant problems of rehydration of the inorganic binder, with a consequent loss in the mechanical strength and the risk of deformation (swelling, partial or even total collapse). Deformation of the cores can also cause residual tensions in the manufactured metal product, which in some cases may jeopardize their integrity, functionality and durability under operating conditions. Other types of paints have considerable drawbacks, again as a result of the emission of harmful substances due to the organic solvents contained therein (such as, for example, hydrocarbons, esters, chlorinated organic substances).

Finally, the use of hydraulic cements as binders for the production of cores is also known (U.S. Pat. No. 3,874,885), which however have problems relating to the transfer of water vapour during the casting. This water vapour causes blowing and porosity in the manufactured metal product. Furthermore, if the casting is carried out according to a so-called “low pressure” process, the development of gases and vapours can cause the blockage of the molten metal in the casting channels. Finally, the removal of these cores is extremely problematical.

The objective of the present invention is to identify a cementitious composition for use as a coating for disposable foundry cores and the relative cores thus coated, said compositions having high mechanical characteristics, which allow end-products to be obtained, characterized by an optimum surface finish, having a reduced environmental impact and, at the same time, being easily removable at the end of the cooling of the metal or alloy, i.e. overcoming the drawbacks of the known art described above.

An object of the present invention relates to the use of a cementitious composition as a coating for disposable foundry cores, said cementitious composition comprising:
at least one binder or hydraulic cement in a quantity ranging from 40% to 99.9% by weight, preferably from 50% to 70% by weight, with respect to the total weight of the cementitious composition;
possibly one or more fillers in a quantity ranging from 0.1% to 60% by weight, preferably from 25% to 45% by weight, with respect to the total weight of the cementitious composition, said filler preferably having a D99<100 μm;
at least one rheology modifying agent selected from cellulose, derivatives of cellulose such as methylhydroxyethylcellulose, vinyl acetate/-versatate copolymers, polycarboxylate ether polymer, or a mixture thereof, in a quantity ranging from 0.1% to 5% by weight with respect to the total weight of the cementitious composition, preferably from 0.1% to 3% with respect to the total weight of the cementitious composition.

A further object of the present invention relates to a disposable foundry core substantially made of sandy material and a binder, preferably inorganic, characterized in that it is coated with one or more layers of coating composed of a cementitious composition comprising
at least one binder or hydraulic cement in a quantity ranging from 40% to 99.9% by weight, preferably from 50% to 70% by weight, with respect to the total weight of the cementitious composition;
possibly one or more fillers in a quantity ranging from 0.1% to 60% by weight, preferably from 25% to 45% by weight, with respect to the total weight of the cementitious composition, said filler preferably having a D99<100 μm;
at least one rheology modifying agent selected from cellulose, derivatives of cellulose such as methylhydroxyethylcellulose, vinyl acetate/-versatate copolymers, polycarboxylate ether polymer, or a mixture thereof, in a quantity ranging from 0.1% to 5% by weight with respect to the total weight of the cementitious composition, preferably from 0.1% to 3% with respect to the total weight of the cementitious composition

and water;

said one or more layers of coating having an overall thickness ranging from 0.15 mm to 1 mm.

Disposable foundry cores are cores generally used in melting processes. The cores produced with inorganic binders, such as for example those produced with the CORDIS method previously mentioned, are used in aluminium melting processes as they are not suitable for use in melting processes of metals at higher temperatures, such as, for example, cast iron.

The solution according to the present invention allows considerable advantages to be obtained, such as a high mechanical strength and a high abrasion resistance of the core (which are also maintained during the casting), the absence of harmful emissions, a reduction in gaseous emissions during the casting of the metal or alloy, optimum desanding, an improved resistance to storage of the cores, also under conditions of high environmental humidity, and an enhanced quality of the surface of the manufactured metal products, thanks to the reduction in the adhesion of sand residues and a reduction in penetrations of metal into the core.

This latter feature also considerably reduces the need for further finishing treatment of the manufactured metal product: an additional benefit is therefore represented by a reduction in cleaning operations of machines and tools, which contributes to increasing the production efficiency of the foundry.

A further advantage of the core coated with the cementitious composition according to the present invention is that said cementitious composition applied on the surface of the core does not complicate its removal at the end of the casting, and it does not jeopardize the re-use of at least part of the sand or sandy material coated.

Furthermore, the cementitious composition, whose use as coating is object of the present invention, when mixed with water and applied as a coating for cores made of sandy material, surprisingly allows coated cores to be produced that do not have mechanical sagging and deformations, either in the forming step or during the storage period, or during the casting step. One of the features of the cementitious composition according to the present invention, in fact, specifically lies in its capacity of not transferring water to the substrate.

As indicated above, the cementitious composition for use as a coating for disposable foundry cores according to the present invention comprises
at least one binder or hydraulic cement in a quantity ranging from 40% to 99.9% by weight, preferably from 50% to 70% by weight, with respect to the total weight of the cementitious composition;
possibly one or more fillers in a quantity ranging from 0.1% to 60% by weight, preferably from 25% to 45% by weight, with respect to the total weight of the cementitious composition, said filler preferably having a D99<100 μm;
at least one rheology modifying agent selected from cellulose, derivatives of cellulose such as methylhydroxyethylcellulose, vinyl acetate/-versatate copolymers, polycarboxylate ether polymer, or a mixture thereof, in a quantity ranging from 0.1% to 5% by weight with respect to the total weight of the cementitious composition, preferably from 0.1% to 3% with respect to the total weight of the cementitious composition.

The term “binder or hydraulic cement” refers, according to the present invention, to a material in powder form which, when mixed with water, forms a paste which hardens by hydration and which, after hardening, maintains its strength and stability even underwater.

The binder or hydraulic cement of the cementitious composition used as coating according to the present invention is preferably selected from Portland cement, sulfoaluminate cement and/or aluminous cement and/or fast natural cement of the “ciment prompt” type. These cements can also be used in a mixture with each other and/or in a mixture with common cement.

The Portland cement according to the present invention is Portland cement type I with strength class 42.5 or 52.5, with an ordinary (N) or high (R) initial strength class, according to the standard UNI EN 197-1:2011, preferably CEM I 52.5R or CEM I 52.5N, even more preferably CEM I 52.5R.

Preferred binders or hydraulic cements are sulfoaluminate cement and/or aluminous cement and, even more preferably sulfoaluminate cement.

Sulfoaluminate cement is obtained by grinding sulfoaluminate clinker and adding variable quantities of calcium sulfate, lime, limestone and other components as described by the standard EN 197-1:2011. There are various examples of clinkers and sulfoaluminate cements on the market or described in patents. Clinkers or sulfoaluminate cements on the market are for example: Lafarge Rockfast®, Italcementi Alipre®, Buzzi Next® clinker, Vicat Alpenat® S, Denka® CSA and those described in the Chinese standard GB 20472-2006.

Suitable sulfoaluminate clinkers or cements are also described in patents or patent applications: for example in FR2873336, EP0812811, EP2640673 (of the same Applicant), US2013018384 A1, WO2013/023728A2 and US20140364543. Considering, in fact, the high productivity that characterizes forming processes of cores, a preferred cementitious composition for use as coating is a cementitious composition with a rapid setting and hardening, which comprises as main binder or hydraulic cement, a fast binder selected from aluminous and/or sulfoaluminate cements and/or common cement according to the standard UNI EN 197-1:2011 Cement—Part 1: Composition, specifications and compliance criteria for common cements, possibly with additives or accelerated.

A cementitious composition comprising, as hydraulic binder, sulfoaluminate cement or aluminous cement and/or relative mixtures, is preferred, as it is particularly advantageous: as it is capable, in fact, of rapidly binding a high quantity of water, it allows rapid implementation times of the coated core and minimizes the risk of transferring water vapour during the casting step.

Even more preferably, among cements that develop hydration products binding high quantities of water, sulfoaluminate cement has proved to be optimum, which, when used as single binder and mixed with water, filler and additives, has allowed a formulation to be obtained which is capable of guaranteeing easy application, fast drying times and excellent surface finishing of the metal surfaces in contact with the cores.

Again taking into account the high productivity that characterizes forming processes of cores, the cementitious coating composition can also comprise accelerating additives of the setting and/or hardening times so as to reduce the curing time required before handling and consequently using the coated cores.

When the hydraulic binder is Portland cement, the cementitious coating composition also comprises accelerating additives of the setting and/or hardening times such as, for example, lithium carbonate, sodium carbonate, aluminium hydroxide, lithium sulfate, calcium nitrate and/or nitrite, preferably lithium carbonate or sodium carbonate, sodium chloride.

The cementitious coating composition, moreover, also comprises rheology modifying agents, i.e. additives capable of modifying the water retention and adhesion characteristics to the support such as vinyl-acetate, vinyl-versatate, methylcellulose, methylhydroxyethylcellulose, preferably methylhydroxy-ethylcellulose (available on the market with the name Culminal C4051).

“Rheology modifying agent” (or also “rheology modifier”) refers to a substance which, when present in a cementitious composition, is capable of modifying its rheological properties in the fresh state and adhesion to the substrate.

In the cementitious composition for use as coating according to the present invention, superfluidifying additives are also present, whose use, as is known in the art, allows the desired rheological characteristics to be optimized within the formulation, characterized by a low water/binder ratio. Among superfluidifying additives, acrylic-based polycarboxylates are preferred, dosed in relation to the temperature of the mixture, the environmental temperature and the degree of fluidity required in the formulation. Other possible additives are lignosulfonates, naphthalene sulfonates, melamine or vinyl compounds.

The filler according to the present invention is defined by the standard UNI EN 12620-1:2008 as an aggregate, most of which passes an 0.063 mm sieve, an aggregate that can be added to building materials for giving them various properties. The filler in the cementitious composition according to the present invention is preferably also characterized by a value of D99.

D99 means, with reference to the particle size of a material, the size of the side of the sieve mesh which allows the passage of 99% of the mass of material being examined.

Preferred fillers according to the present invention are limestone, siliceous or silico-calcareous fillers, more preferably limestone fillers, alone or in a mixture.

The binder used with the sandy material for producing the core is preferably a binder of the inorganic type which comprises sodium silicate, sodium phosphate, sodium polyphosphate, sodium tetraborate (also called borax) or a mixture thereof and water. An example of said inorganic binder is described in the document previously cited (CORDIS method; Satef Group; 2 Oct. 2015) wherein the disposable core is produced by mixing sand with the inorganic binder in the presence of water as sole solvent, and subsequently dried by degassing with hot air at 170-200° C. and a pressure of 3-5 bar, in a core box heated to 130-200° C.

The core thus produced is then subjected to a coating process with the cementitious composition described above, mixed with water.

The coating material used according to the present invention consists of a mixture of cementitious composition and water, wherein the weight ratio water/cementitious composition ranges from 0.3 to 0.8, in relation to parameters such as, for example, the particle size of the filler and aggregate, the type and dosage of the binder, the type and dosage of the additives, the application method, the temperature of the environment and of the materials.

Said coating is preferably applied to the disposable core by brushing or airbrushing or by immersion in a bath of liquid product. One or more coating layers are applied, until the desired thickness is reached.

In the present document, “water retention” refers to the mass of water treated by a cementitious composition following suction treatment effected according to the standard UNI EN 459-2:2010 (Building lime—Test methods) and is expressed as a mass percentage with respect to the original water content.

Examples of Formulations According to the Invention

A preferred formulation of the cementitious composition for use as a coating according to the present invention is indicated in the following Table 1:

TABLE 1
(preferred formulation)

| | Trade- | | |
|---|---|---|---|
| Component | name | Producer | Weight % |
| Sulfoaluminate cement | Alicem | Italcementi | 69% |
| Filler or limestone aggregate | SR60 | Mineraria | 28% |
| D99 < 100 μm; CaCO₃ > 99% | | Abruzzese | |
| Methylhydroxyethylcellulose | Culminal | Ashland | 0.20% |
| (MHEC) as rheology modifying | C4051 | Specialty | |
| agent | | Ingredients | |
| Brookfield RVT viscosity | | | |
| at 20° C.: 75000 mPa · s | | | |
| Redispersible polymeric binder | Elotex | Akzo Nobel | 1.40% |
| based on vinyl-acetate and vinyl- | FL1210 | Chemicals | |
| versatate (copolymer) as rheology | | | |
| modifying agent and adhesion | | | |
| enhancer | | | |
| Superfluidifying additive - | Melflux | BASF | 1.40% |
| polycarboxylate ether polymer | 1641F | | |
| (PCE) | | | |
| Total | | | 100% |

TABLE 2

| | Trade- | | |
|---|---|---|---|
| Component | name | Producer | Weight % |
| Portland Cement | i.tech | Italcementi | 52.50 |
| | ULTRACEM | | |
| | CEM I 52.5 R | | |
| Limestone filler | Calcium | Cremaschi | 44 |
| (D100 = 250 μm) | carbonate: | Granulati | |
| | ventilated 1/A | | |
| Redispersible polymeric | FX4310 | Elotex | 1.30 |
| binder based on vinyl-acetate | | | |
| and vinyl-versatate and | | | |
| butylacrylate | | | |
| Methylcellulose (Ubbelohde | Methocell 228 | Dow | 0.20 |
| Viscosity, 2% in water at | | Chemical | |
| 20° C.: 5000 mPa · s) | | | |
| Superfluidifying additive | Melment F10 | Degussa | 2.00 |
| melamine | | | |
| Total | | | 100% |

TABLE 3

| | Trade- | | Weight |
|---|---|---|---|
| Component | name | Producer | % |
| Sulfoaluminate cement | Alicem | Italcementi | 47.5% |
| Portland Cement with limestone | i.work | Italcementi | 22% |
| | TECNOCEM | | |
| | CEMII/A-LL | | |
| | 42.5 R | | |
| Filler or limestone aggregate | SR60 | Mineraria | 28% |
| D99 < 100 μm; CaCO₃ > 99% | | Abruzzese | |
| Methylhydroxyethylcellulose | Culminal | Ashland | 0.2% |
| (MHEC) as rheology modifying | C4051 | Specialty | |
| agent | | Ingredients | |
| Brookfield RVT viscosity | | | |
| at 20° C.: 75000 mPa · s | | | |
| Redispersible polymeric binder | Elotex FL1210 | Akzo Nobel | 1.3% |
| based on vinyl-acetate and vinyl- | | Chemicals | |
| versatate (copolymer) as | | | |
| rheology modifying agent and | | | |
| adhesion enhancer | | | |
| Superfluidifying additive - | Melflux | BASF | 1.00% |
| polycarboxylate ether polymer | 1641F | | |
| (PCE) | | | |
| Total | | | 100% |

The viscosity of the rheology modifying agent in Tables 1 and 3 is measured in accordance with the standard ASTM D2196-15, and more specifically according to the method “Brookfield RVT” method described in said standard.

The functioning principle of Brookfield viscometers is based on the rotation of a rotor immersed in a fluid contained in a vessel. In this configuration, the torque necessary for overcoming the motion resistance of the fluid, is measured. According to an embodiment of the present invention, the rheology modifying agent is of the cellulose type and has a Brookfield RVT measured at 20° C. which varies within a range of 2,000 to 100,000 mPa·s.

In Tables 2 and 4, the viscosity value of the rheology modifying agent is measured according to the standards ASTM D445-15a and ASTM D446-12, and more specifically according to the “Ubbelohde” method described in said standards. The measuring principle of Ubbelohde viscometers is of the capillary type and is based on the measurement of the time a fluid takes for flowing between two predefined targets on a capillary tube. A Ubbelohde viscometer is U-shaped and is similar to an Oswald viscometer. According to an embodiment of the present invention, the rheology modifying agent is of the cellulose type and has a Ubbelohde viscosity within the range of 100 to 500 mPa·s.

The premixed product is prepared by the simple addition of water; the ratio between water and premixed product is indicated in the following examples.

The formulations of the cementitious composition for use as a coating for disposable foundry cores according to the present invention indicated in Tables 1-3 were used in the following examples, provided for purely illustrative and non-limiting purposes and from which other features and advantages of the invention will appear evident.

The measurements of the thickness of the coating indicated in the examples were obtained with a thickness gauge for “comb”-type coatings and are the average of measurements effected at multiple points of the pieces treated. Each thickness value is accompanied by a variability range calculated on the basis of the standard deviation of the set of measurements.

### EXAMPLE 1

Various tests were carried out, applying the formulation of the cementitious composition indicated in Table 1, mixed with water in the following weight ratios:

1 part of cementitious composition, 0.55 parts of water.

The coating was applied on an inorganic core produced according to the CORDIS method as previously described, applying said coating either by brushing or by spraying with an airbrush.

These cores are destined for the production of aluminium end-products produced with the jet technology at both low pressure at 1.2 bar and by casting at atmospheric pressure.

Test Nr.1.1a

Low-pressure aluminium jet at 1.2 bar, using non-coated inorganic cores and coated inorganic cores according to Example 1.

Type of piece: parts of car chassis

Application: Brush

Application thickness: 400 μm±50 μm (one layer)

Pieces obtained using non-coated cores: 2

Pieces obtained using coated cores: 2

Curing period: 7 days

Test Result

Pieces obtained using non-coated cores:
unsatisfactory finish due to the penetration of molten aluminium into the inorganic core;
weight of the piece 30% higher with respect to the project weight due to the aluminium penetrated into the core; the excess metal causes a cost increase and a degradation in the performances, as the weight is a production specification.

Pieces obtained using coated cores:
satisfactory finish, indicating an adequate impermeability of the inorganic core to molten aluminium;
weight of the piece equal to the project weight with consequent compliance in terms of cost and performances.

Test Nr.1.1b

Low-pressure aluminium jet at 1.2 bar, using non-coated inorganic cores and coated inorganic cores according to Example 1.

Type of piece: parts of car chassis

Application: Airbrush (nozzle diameter: 1.9 mm, air pressure: 5 bar)

Application thickness: 300 μm±50 μm (4 layers)

Pieces obtained using non-coated cores: 4

Pieces obtained using coated cores: 4

Curing period: 2 days

Test Result

Pieces obtained using non-coated cores:
unsatisfactory finish due to the penetration of molten aluminium into the inorganic core;
weight of the piece 30% higher with respect to the project weight due to the aluminium penetrated into the core; the excess metal causes a cost increase and a degradation in the performances, as the weight is a production specification.

Pieces obtained using coated cores:
satisfactory finish, indicating an adequate impermeability of the inorganic core to molten aluminium;
weight of the piece equal to the project weight with consequent compliance in terms of cost and performances.

Test Nr.1.2a

Aluminium jet by casting at atmospheric pressure, using non-coated inorganic cores and coated inorganic cores according to Example 1.

Type of piece: brake calipers

Application: Brush

Application thickness: 410 μm±50 μm (one layer)

Pieces obtained using non-coated cores: 3

Pieces obtained using coated cores: 3

Curing period: 7 days

Test Result

Pieces obtained using non-coated cores:
satisfactory finish, difficulty in handling and storing the cores due to the tendency of losing mechanical strength following moisture absorption.

Pieces obtained using coated cores:
satisfactory finish, better handling and longer storage possibilities due to protection against environmental moisture offered by the coating.

Test Nr.1.2b

Aluminium jet by casting at atmospheric pressure, using non-coated inorganic cores and coated inorganic cores according to Example 1.

Type of piece: brake calipers

Application: Airbrush (nozzle diameter: 1.9 mm, air pressure: 5 bar)

Application thickness: 200 μm±50 μm (two layers)

Pieces obtained using non-coated cores: 3

Pieces obtained using coated cores: 3

Curing period: 2 days

Test Result

Pieces obtained using non-coated cores:
unsatisfactory finish;

Pieces obtained using coated cores:
satisfactory finish.

Test Nr.1.2c

Aluminium jet by casting at atmospheric pressure, using non-coated inorganic cores and coated inorganic cores according to Example 1.

Type of piece: brake calipers

Application: Airbrush (nozzle diameter: 1.9 mm, air pressure: 5 bar)

Application thickness: 290 μm±50 μm (four layers)

Pieces obtained using non-coated cores: 3

Pieces obtained using coated cores: 3

Curing period: 2 days

Test Result

Pieces obtained using non-coated cores:
unsatisfactory finish;

Pieces obtained using coated cores:
satisfactory finish.

### EXAMPLE 2

Various tests were carried out, applying the formulation of the cementitious composition indicated in Table 2, mixed with water in the following weight ratios:

1 part of cementitious composition, 0.65 parts of water.

The coating was applied on an inorganic core produced according to the CORDIS method as previously described, applying said coating by brushing.

These cores are destined for the production of aluminium end-products produced with the jet technology by casting at atmospheric pressure.

Test Nr.2.1

Aluminium jet by casting at atmospheric pressure, using non-coated inorganic cores and coated inorganic cores, as previously described.

Type of piece: engine bases

Application: Brush

Pieces obtained using non-coated cores: 20

Pieces obtained using coated cores: 20

Application thickness: 350 μm±50 μm (one layer)

Curing period:
Lot 1: 7 days
Lot 2: 30 days

Test Result

Pieces obtained using non-coated cores:
unsatisfactory finish due to a moderate penetration of molten aluminium into the inorganic core;
weight of the piece 20% higher with respect to the project weight due to the aluminium penetrated in the core.

Pieces obtained using coated cores:
satisfactory finish, indicating an adequate impermeability of the inorganic core of the “CORDIS” type to molten aluminium;
weight of the piece equal to the project weight.

Characterization tests were carried out on the product to evaluate the effective capacity of not transferring water to the substrate. This feature is important as an excess supply of water to the substrate can cause a degradation of the performances. This property was assessed by measuring the water retention in compliance with the standard UNI EN 459-2:2010 (Building limes—Test methods).

The results are indicated in Table 4 below.

TABLE 4

| Examples | Product | Water retention |
|---|---|---|
| 1 | Composition of Table 1 | 96.25% |
| 2 | Composition of Table 2 | 96.15% |
| Reference/comparison | Interior pain | 87.00% |

The reference/comparison consists of an interior paint which is an acrylic-based breathable paint for plasters having the trade-name “Sistema Colore”, sold by Fassa Bortolo.

As is known, cementitious materials require prolonged curing times after the jet to allow the development of hydration reactions and enable them to be put into operation. The drying and curing times of the product were evaluated and the results are indicated in Table 5.

TABLE 5

| | Time necessary for |
|---|---|
| Application | handling the coated cores |
| Application: Airbrush | 15 minutes |
| Application thickness: 200 μm (two layers) | |
| Application: Airbrush | 45 minutes |
| Application thickness: 300 μm (four layers) | |

The time necessary for handling the coated cores is a parameter having an important impact on the productivity of the melting process. In both of the examples of Table 5, the value measured is compatible with normal foundry processes; this time can also be regulated in relation to the layers of application of the coating. A time in the order of an hour is not industrially acceptable.

1. Use of a cementitious composition as a coating for disposable foundry cores, said cementitious composition comprising:
at least one binder or hydraulic cement in a quantity ranging from 40% to 99.9% by weight, with respect to the total weight of the cementitious composition;
optionally, one or more fillers in a quantity ranging from 0.1% to 60% by weight, with respect to the total weight of the cementitious composition;
at least one rheology modifying agent selected from cellulose, derivatives of cellulose such as methylhydroxyethylcellulose, vinyl acetate/versatate copolymers, polycarboxylate ether polymer, or a mixture thereof, in a quantity ranging from 0.1% to 5% by weight, with respect to the total weight of the cementitious composition.

2. The use according to claim 1, wherein the binder or hydraulic cement is selected from Portland cement, sulfoaluminate cement and/or aluminous cement and/or rapid natural cement of the “ciment prompt” type, alone or mixed with each other and/or in a mixture with common cement, optionally containing additives or accelerated.

3. The use according to claim 1, wherein the binder or hydraulic cement is Portland cement type I with a strength class 42.5 or 52.5, with an ordinary (N) or high (R) initial strength class, according to the standard UNI EN 197-1:2011.

4. The use according to claim 1, wherein the binder or hydraulic cement is sulfoaluminate cement.

5. The use according to claim 1, wherein the filler is selected from the group consisting of limestone, siliceous and silico-calcareous fillers, including combinations thereof.

6. The use according to claim 1, wherein the rheology modifying agent is methylhydroxyethylcellulose.

7. The use according to claim 1, wherein the cementitious composition further comprises superfluidifying additives and/or other additives.

8. A disposable foundry core substantially consisting of sandy material and a core binder, characterized in that it is coated with one or more coating layers consisting of a cementitious composition comprising:
at least one binder or hydraulic cement in a quantity ranging from 40% to 99.9% by weight, with respect to the total weight of the cementitious composition;
optionally, one or more fillers in a quantity ranging from 0.1% to 60% by weight, with respect to the total weight of the cementitious composition;
at least one rheology modifying agent selected from cellulose, derivatives of cellulose such as methylhydroxyethylcellulose, vinyl acetate/-versatate copolymers, polycarboxylate ether polymer, or a mixture thereof, in a quantity ranging from 0.1% to 5% by weight with respect to the total weight of the cementitious composition
and water;
said one or more coating layers having an overall thickness ranging from 0.15 mm to 1 mm.

9. (canceled)

10. The core according to claim 8, wherein the water/cementitious composition weight ratio ranges from 0.3 to 0.8.

11. The core according to claim 8, wherein the coating is applied to the core by brushing, airbrushing, by immersion in a coating bath, or by combinations thereof.

12. The use according to claim 1, wherein the binder or hydraulic cement is in a quantity ranging from 50% to 70% by weight, with respect to the total weight of the cementitious composition.

13. The use according to claim 1, wherein said one or more fillers are in a quantity ranging from 25% to 45% by weight, with respect to the total weight of the cementitious composition.

14. The use according to claim 1, wherein said one or more fillers have a D99<100 μm.

15. The use according to claim 1, wherein said rheology modifying agent is in a quantity ranging from 0.1% to 3%, with respect to the total weight of the cementitious composition.

16. The use according to claim 1, wherein the binder or hydraulic cement is taken from the group consisting of CEM I 52.5R, CEM I 52.5N, sulfoaluminate cement, aluminous cement and combinations thereof.

17. The use according to claim 7, wherein the superfluidifying additives are acrylic-based polycarboxylates.

18. The use according to claim 7, wherein the further additives are taken from the group consisting of lignosulfonates, naphthalene sulfonates, melamine, vinyl compounds and combinations thereof.

19. The core according to claim 8, wherein the binder or hydraulic cement is in a quantity ranging from 50% to 70% by weight, with respect to the total weight of the cementitious composition.

20. The core according to claim 8, wherein said one or more fillers, when used, are in a quantity ranging from 25% to 45% by weight, with respect to the total weight of the cementitious composition.

21. The core according to claim 8, wherein said one or more fillers, when used, have a D99<100 μm.

22. The core according to claim 8, wherein said rheology modifying agent is in a quantity ranging from 0.1% to 3%, with respect to the total weight of the cementitious composition.
